(19) United States
(12) Patent Application Publication
(10) Pub. No.: US 2003/0220842 A1
(43) Pub. Date: Nov. 27, 2003

(54) Order receiving system, information providing apparatus, order receiving apparatus and recording medium

(75) Inventors: Ricoe Watanabe, Tokyo (JP); Nobuhiro Miyatake, Tokyo (JP); Kenichiro Osada, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: GLOBAL MEDIA ONLINE INC., Tokyo (JP)

(21) Appl. No.: 10/065,906

(22) Filed: Nov. 28, 2002

Related U.S. Application Data
(63) Continuation of application No. PCT/JP00/03587, filed on Jun. 1, 2000.

(51) Int. Cl. G06F 17/60

(52) U.S. Cl. 705/26

(57) ABSTRACT

An order receiving system for receiving a merchandise order, includes an information providing unit 300 for providing to a terminal 16 or 18 merchandise information including merchandise specifying information which specifies the merchandise; an order information inputting unit for inputting the merchandise specifying information supplied from the terminal 16 or 18 which has received the merchandise information; a notifying unit for notifying a store terminal 20 related to a store dealing with the merchandise of order information of the merchandise according to the merchandise specifying information inputted into the order information inputting unit; a confirmation information inputting unit for inputting confirmation information, which indicates that the order information has been confirmed, from the store terminal 20; an order information storing unit for storing the order information and the confirmation information with making the order and confirmation information be corresponding to each other; and an unconfirmed order information detecting unit for detecting the order information which does not have any confirmation information corresponded to it, and making the notifying unit notify of the order information again.

### CROSS REFERENCE TO RELATED APPLICATIONS

The present application is a continuation application of PCT application No. PCT/JP00/03587 and claims priority therefrom, the contents of which are incorporated herein by reference.

### BACKGROUND OF INVENTION

1. Field of the Invention

The present invention is related to an order receiving system, an information providing apparatus, an order receiving apparatus, and a recording medium. In particular, the present invention is related to an information providing apparatus for providing merchandise information via a network, an order receiving apparatus for receiving a merchandise order via a network, an order receiving system including the information providing apparatus and the order receiving apparatus, and a recording medium.

2. Related Art

There is a conventional apparatus which receives a merchandise order via a network and directs to deliver the ordered merchandise to a place designated by a customer. An apparatus capable of receiving merchandise orders is disclosed in Japanese Patent Application No. 11-39396.

The apparatus described in the Japanese Patent Application No. 11-39396 notifies a store dealing with ordered merchandise of information of ordered merchandise. However, the conventional apparatus has no function to check whether or not the store has received and confirmed the order.

### SUMMARY OF INVENTION

Thus, it is an object of the present invention to provide an order receiving system, an information providing apparatus, an order receiving apparatus, and a recording medium capable of solving the aforementioned problem.

According to the first aspect of the present invention, there is provided an order receiving system for receiving a merchandise order, including: an information providing unit for providing to a terminal merchandise information including merchandise specifying information which specifies the merchandise; an order information inputting unit for inputting the merchandise specifying information supplied from the terminal which has received the merchandise information; a notifying unit for notifying a store terminal related to a store dealing with the merchandise of order information of the merchandise according to the merchandise specifying information inputted into the order information inputting unit; a confirmation information inputting unit for inputting confirmation information, which indicates that the order information has been confirmed, from the store terminal; an order information storing unit for storing the order information and the confirmation information with making the order and confirmation information be corresponding to each other; and an unconfirmed order information detecting unit for detecting the order information which does not have any confirmation information corresponded to it, and making the notifying unit notify of the order information again.

According to another embodiment of the first aspect of the present invention, the order receiving system further includes a location information acquiring unit for acquiring location information of the terminal; an information storing unit for storing the merchandise information and area information of an area, where the merchandise information is valid, with making the merchandise information be corresponding to the area information; and a selecting unit for selecting the merchandise information, which is provided to the terminal, from the information storing unit according to the location information and the area information, wherein the information providing unit provides the merchandise information selected by the selecting unit to the terminal. And, the order receiving system further includes a terminal recognizing unit for detecting whether or not the terminal is a mobile station of a wireless system, wherein the location information acquiring unit includes: a mobile terminal location information acquiring unit for acquiring the location information of the terminal from a location information providing apparatus which provides the location information of the terminal, in case the terminal is a mobile station; and a fixed terminal location information acquiring unit for acquiring the location information of the terminal stored in advance, in case the terminal is not a mobile station.

According to a second aspect of the present invention, there is provided an order receiving apparatus for receiving a merchandise order, including: an order information inputting unit for inputting merchandise specifying information which specifies the merchandise from the terminal; a notifying unit for notifying a store terminal related to a store dealing with the merchandise of order information of the merchandise according to the merchandise specifying information; a confirmation information inputting unit for inputting confirmation information, which indicates that the order information has been confirmed, from the store terminal; an order information storing unit for storing the order information and the confirmation information with making the order and confirmation information be corresponding to each other; and an unconfirmed order information detecting unit for detecting the order information which does not have any confirmation information corresponded to it, and making the notifying unit notify of the order information again.

According to another embodiment of the second aspect of the present invention, the order receiving apparatus further includes a confirmation notifying unit for notifying the terminal, which provides the merchandise specifying information to the order information inputting unit, of receipt information showing that the merchandise order is received, in case the confirmation information inputting unit inputs the confirmation information. And, the unconfirmed order information detecting unit detects the order information, which is not corresponded to the confirmation information, for a predetermined time period. And, the order receiving apparatus further includes a change request notifying unit for notifying the terminal of change request information requesting change of the merchandise, wherein the unconfirmed order information detecting unit notifies the change request notifying unit of the change request information, in case order information which is not corresponded to the confirmation information is detected.

According to a third aspect of the present invention, there is provided an information providing apparatus for providing information, including: an information storing unit for storing the information and area information, which designates an area where the information is valid, with making the information be corresponding to the area information; a location information acquiring unit for acquiring location information of a terminal which provides the information; and a selecting unit for selecting the information provided to the terminal according to the area information and the location information; and an information providing unit for providing the information selected by the selecting unit to the terminal.

According to another embodiment of the third aspect of the present invention, the information providing apparatus further includes a terminal recognizing unit for detecting whether or not the terminal is a mobile station of a wireless system, wherein the location information acquiring unit includes: a mobile terminal location information acquiring unit for acquiring the location information of the terminal from a location information providing apparatus which provides the location information of the terminal, in case the terminal is a mobile station; and a fixed terminal location information acquiring unit for acquiring the location information of the terminal stored in advance, in case the terminal is not a mobile station.

According to a fourth aspect of the present invention, there is provided a computer readable recording medium on which a computer program is recorded, the program including: a module for inputting merchandise specifying information which specifies the merchandise; a module for notifying a store terminal related to a store dealing with the merchandise of order information of the merchandise according to the merchandise specifying information; a module for inputting confirmation information, which indicates that the order information has been confirmed, from the store terminal; a module for storing the order information and the confirmation information with making the order and confirmation information be corresponding to each other; and a module for detecting the order information which does not have any confirmation information corresponded to it, and making the order information be notified again.

According to a fifth aspect of the present invention, there is provided a computer readable recording medium on which a computer program is recorded, the program including: a module for storing a predetermined information and area information, which designates an area where the predetermined information is valid, with making the predetermined information be corresponding to the area information; a module for acquiring location information of a terminal which provides the predetermined information; and a module for selecting the predetermined information provided to the terminal according to the area information and the location information; and a module for providing the selected predetermined information to the terminal.

The above summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 shows an example of a functional block diagram of an order receiving system 500.

FIG. 2 shows an example of a functional block diagram of an information providing apparatus 100.

FIG. 3 shows an example of a functional block diagram of an order receiving apparatus 200.

FIG. 4 shows an example of a database stored in an information storing unit 300.

FIG. 5 shows an example of a data-structure of a store database 302.

FIG. 6 shows an example of a data-structure of a merchandise database 304.

FIG. 7 shows an example of a data-structure of a user database 306.

FIG. 8 shows an example of a data-structure of an order informat ion database 308.

FIG. 9 shows an example of a displaying screen.

FIG. 10 shows another example of a displaying screen.

FIG. 11 shows another example of a displaying screen.

FIG. 12 shows an example of a functional block diagram of information providing apparatus 100.

### DETAILED DESCRIPTION

The invention will now be described based on the preferred embodiments, which do not intend to limit the scope of the present invention, but exemplify the invention. All of the features and the combinations thereof described in the embodiment are not necessarily essential to the invention.

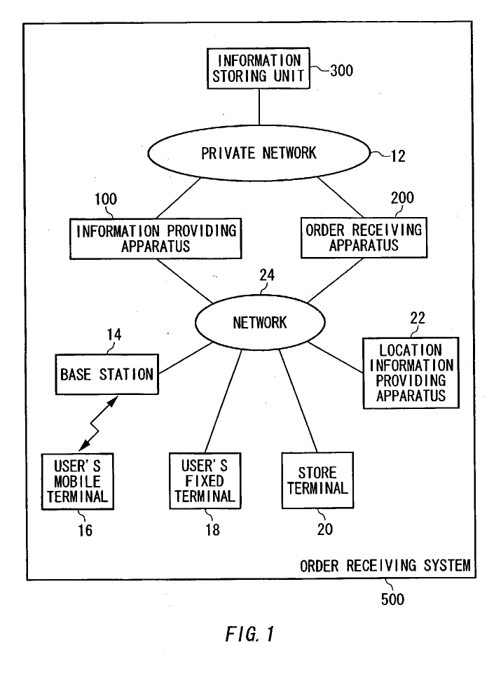

FIG. 1 shows an example of a functional block diagram of an order receiving system 500. The order receiving system 500 includes a network 24, a base station 14, a users mobile terminal 16, a users fixed terminal 18, a store terminal 20, a location information providing apparatus 22, an information providing apparatus 100, an order receiving apparatus 200, a private network 12, and an information storing unit 300.

The private network 12 connects the order receiving apparatus 200, the information storing unit 300 and the information providing apparatus 100 to one another. The network 24 connects the location information providing apparatus 22, the information providing apparatus 100, the order receiving apparatus 200, the base station 14, the user's mobile terminal, the users fixed terminal and the store terminal to one another. The users mobile terminal 16 is a mobile station in a wireless system, and thus communicates with the base station 14 by wireless system. Therefore, the users mobile terminal 16 connects with the network 24 via the base station 14.

Either of the users mobile terminal 16 and the users fixed terminal 18 is a terminal related to the user for ordering merchandise by the order receiving system 500, and thus the user requests the information providing apparatus 100 to provide merchandise information through either mobile or fixed terminal 16 or 18. In case the information providing apparatus 100 is requested to provide the merchandise information, the information providing apparatus 100 provides merchandise information to a request terminal (the users mobile or fixed terminal), which is a source of the request for merchandise information, by acquiring merchandise information from the information storing unit 300.

For example, the information storing unit 300 stores store information of a store, merchandise information of merchandise dealt with by the store and area information of an area where the merchandise information is valid, correspondingly to one another. According to location information of the request terminal, the information providing apparatus 100 provides merchandise information to the request terminal by acquiring merchandise information from the information storing unit 300. For example, area information of the area where merchandise information is valid may be area information of an area where merchandise dealt with by a store is delivered.

Specifically, the area information may be information on where a restaurant delivers ordered dishes, where a general store delivers miscellaneous goods or where a bicycle deliverer, etc. delivers merchandise. Because the information providing apparatus 100 provides merchandise information on the basis of location information of the request terminal, information related to a store-available at the location of the request terminal may be provided.

The location information providing apparatus 22 detects location information of the users mobile terminal 16 and provides it to the information providing apparatus 100. For example, the location information providing apparatus 22 may acquire location information of the users mobile terminal 16 on the basis of strength of wireless signal, which is transmitted by the users mobile terminal 16 and received by the base station 14. Particularly, in case of detecting location information of the users mobile terminal 16, the information providing apparatus 100 requests the location information providing apparatus 22 to provide location information of the users mobile terminal 16. The location providing apparatus 22 provides detected location information to the information providing apparatus 100. In this way, the information providing apparatus 100 acquires location information of the users mobile terminal 16.

Either users mobile or fixed terminal outputs order information of ordered merchandise to the order receiving apparatus 200. The order receiving apparatus 200 notifies the store terminal 20 related to the store dealing with ordered merchandise of received order information. For example, the store terminal 20 may be a terminal installed in the store, a portable terminal or a mobile station of the wireless system.

Specifically, the order receiving apparatus 200 may notify the store terminal 20 of received order information by means of text information, audio information, image information or etc. In this manner, the store receives an order from the user.

In addition, if the store terminal 20 is a mobile station of the wireless system, the store does not require a space for installing the terminal and thus introduction of the terminal is easy. Further, the expense of introduction of the terminal is relatively cheap.

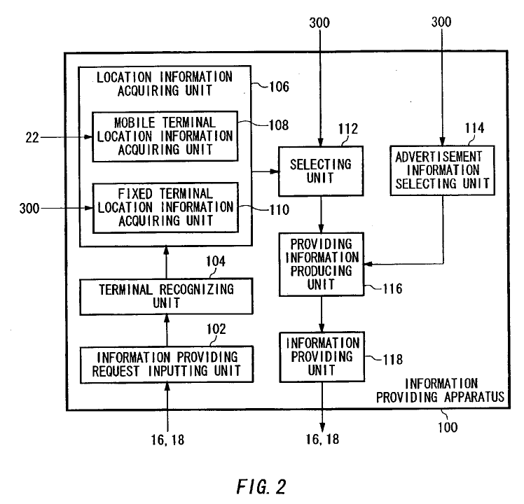

FIG. 2 shows an example of a detailed functional block diagram of the information providing apparatus 100. The information providing apparatus 100 includes an information providing request inputting unit 102, a terminal recognizing unit 104, a location information acquiring unit 106, a selecting unit 112, an advertisement information selecting unit 114, a providing information producing unit 116 and an information providing unit 118. The location information acquiring unit 106 includes a mobile terminal location information acquiring unit 108 and a fixed terminal location information acquiring unit 110. The information providing request inputting unit 102 inputs information providing request which request for provision of merchandise information supplied from the request terminal. The terminal recognizing unit 104 recognizes the request terminal which supplied information providing request. For example, the terminal recognizing unit 104 recognizes the type of the request terminal out of the user's mobile terminal 16 and the user's fixed terminal 18. The terminal recognizing unit 104 outputs the result of recognition to location information acquiring unit 106.

The location information acquiring unit 106 acquires location information of the request terminal on the basis of the recognition result supplied from the terminal recognizing unit 104. In case the request terminal is the user's mobile terminal 16, the location information acquiring unit 106 acquires location information of the user's mobile terminal 16 by the mobile terminal location information acquiring unit 108. In case the request terminal is the user's fixed terminal 18, the location information acquiring unit 106 acquires location information of the user's fixed terminal 18 by the fixed terminal location information acquiring unit 110. The mobile terminal location information acquiring unit 108 acquires location information of the user's mobile terminal 16 from the location information providing apparatus 22. The fixed terminal location information acquiring unit 110 acquires location information of the user's fixed terminal 18 stored in the information storing unit 300.

In this way, the location information acquiring unit 106 acquires location information of the user's mobile terminal 16 or the user's fixed terminal 18. The location information acquiring unit 106 provides the acquired location information of request terminal to the selecting unit 112.

The selecting unit 112 selects merchandise information provided to the request terminal from the information storing unit 300 on the basis of location information supplied from the location information acquiring unit 106. The selecting unit 112 outputs selected merchandise information to the providing information producing unit 116. The advertisement information selecting unit 114 selects advertisement information in the information storing unit 300. The advertisement information selecting unit 114 outputs selected advertisement information to the providing information producing unit 116.

For example, the information storing unit 300 may store information specifying the request terminal and merchandise information ordered from the request terminal, correspondingly to each other. Thus, the advertisement information selecting unit 114 may select advertisement information on the basis of merchandise information ordered previously from the request terminal. For example, in case there are a lot of orders for “Chinese dishes”, the advertisement information selecting unit 114 selects advertisement information of “Chinese dish” and outputs it to the providing information producing unit 116.

The providing information producing unit 16 produces the providing information, which is provided to the request terminal, on the basis of merchandise information supplied from the selecting unit 112 and advertisement information supplied from the advertisement information selecting unit 114. For example, the providing information producing unit 116 produces the providing information on the basis of a sentence description language by which predetermined information is displayed on a displaying screen of the request terminal. For example, the sentence description language may be XML (extensible markup language), HTML (hypertext markup language), or SGML (standard generalized markup language). For example, the providing information producing unit 116 may produce the providing information in response to the type of the request terminal. For example, in case the request terminal is the user's mobile terminal 16, the providing information producing unit 116 may produce the providing information so that the amount of data is as small as possible. Specifically, the providing information producing unit 116 may produce the providing information which doesn't have any image data. The providing information producing unit 116 outputs the providing information to the information providing unit 118.

The information providing unit 118 outputs the providing information to a request terminal. Then, the request terminal displays merchandise information on the displaying screen on the basis of the providing information. The user places a merchandise order by selecting merchandise out of merchandise information displayed on the displaying screen. For example, the request terminal displays a screen to indicate desired merchandise, and thus the user gives an order in response to the screen. In case an order is given by a user, the request terminal outputs order information including information specifying the merchandise.

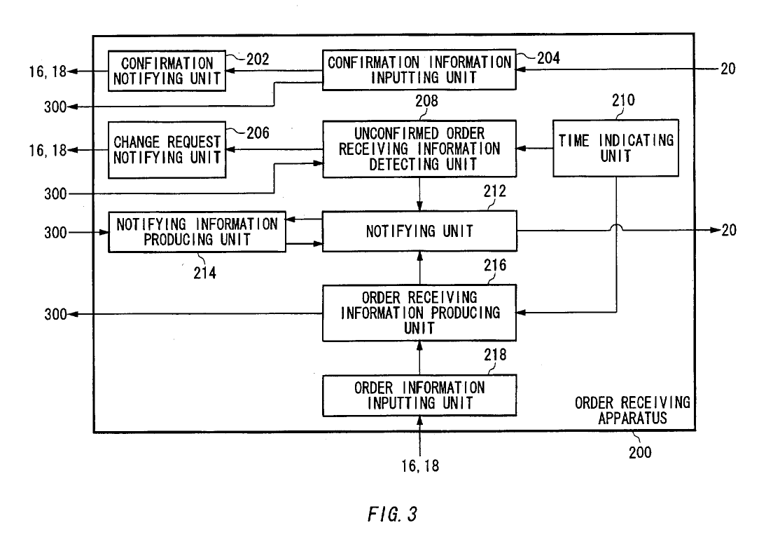

FIG. 3 shows an example of a functional block diagram of the order receiving apparatus 200. The order receiving apparatus 200 includes a confirmation notifying unit 202, a confirmation information inputting unit 204, a change request notifying unit 206, an unconfirmed order receiving information detecting unit 208, a time indicating unit 210, a notifying unit 212, a notifying information producing unit 214, an order receiving information producing unit 216 and an order information inputting unit 218. The order information inputting unit 218 inputs order information supplied from the request terminal via the network 24. The time indicating unit 210 outputs time information to the unconfirmed order information detecting unit 208 and the order receiving information producing unit 216. In this case, time information may be in hour or include date information. The order information inputting unit 218 outputs inputted order information to the order receiving information producing unit 216.

The order receiving information producing unit 216 produces order receiving information including merchandise information and terminal specifying information, which specifies the request terminal placing a merchandise order, on the basis of order information supplied from the order information inputting unit 218. For example, the order receiving information producing unit 216 produces order receiving information produced by making the order receiving information be corresponding to merchandise information included in order information, terminal specifying information specifying a terminal which provides order information to the order information inputting unit 218, time information supplied from the time indicating unit 210 and order specifying information specifying order information. Therefore, the order receiving information producing unit 216 stores the time when the order information inputting unit 218 inputs order information with making the time corresponding to the order specifying information. Herein, the time when the order information inputting unit 218 inputs order information, is defined as “order time”.

For example, the order specifying information may include a number, and the order receiving information producing unit 216 may produce order specifying information by increasing the number at each time the order information is stored. The order receiving information producing unit 216 stores the order receiving information produced in the information storing unit 300. In addition, the order receiving information producing unit 216 directs the notifying unit 212 to notify the store terminal 20 of order receiving information stored. For example, the order receiving information producing unit 216 outputs order specifying information, which specifies order receiving information stored in the information storing unit 300, to the notifying unit 212.

When the notifying unit 212 is directed to notify the store terminal 20 of order receiving information, the notifying unit 212 directs the notifying information producing unit 214 to produce order receiving information which will be notified to the store terminal 20. The notifying unit 212 notifies the store terminal 20 of notifying information, which is produced by the notifying information producing unit 214 according to the direction, via the network 24. The notifying information producing unit 214 produces notifying information, which will be displayed on the displaying screen of the store terminal 20, by acquiring order receiving information directed by the notifying unit 212 from the information storing unit 300.

The notifying information producing unit 214 may produce notifying information according to the sentence description language, such as XML, HTML, SGML and etc. For example, the notifying unit 212 outputs order specifying information, which specifies order receiving information notified to the store terminal 20, to the notifying information producing unit 214. For example, the notifying information producing unit 214 produces notifying information by acquiring order receiving information from the information storing unit 300 according to order specifying information supplied from the notifying unit 212. Thus, the notifying unit 212 notifies the store terminal 20 of merchandise information ordered by the user.

The store terminal 20 outputs confirmation information indicating that order receiving information supplied from the notifying unit 212 has been confirmed. Confirmation information includes order specifying information. For example, when a store clerk has confirmed order receiving information displayed on the store terminal 20, she transmits the confirmation information to the store terminal 20.

The confirmation information inputting unit 204 inputs confirmation information supplied from the store terminal 20. In case the confirmation information inputting unit 204 inputs confirmation information, the confirmation information inputting unit 204 directs the confirmation notifying unit 202 to notify the request terminal of receipt information showing that the order has been received. In addition, the confirmation information inputting unit 204 stores information, which shows that confirmation information is inputted in the information storing unit 300, with making the information be corresponding to the order specifying information. For example, the confirmation information inputting unit 204 may store the time, when confirmation information is inputted, in the information storing unit 300 as information which shows that confirmation information is inputted. Herein, the time, when confirmation information is inputted, is defined as “confirming time”. In this way, it is recognized whether or not the store has confirmed the notifying information notified from the notifying unit 212.

The unconfirmed order information detecting unit 208 detects order receiving information (“unconfirmed order receiving information”)which is not corresponded to confirmation information in the information storing unit 300. When the unconfirmed order information detecting unit 208 detects unconfirmed order receiving information, the unconfirmed order information detecting unit 208 directs the notifying unit 212 to notify the store terminal 20 of notifying information. Therefore, it is prevented that notifying information, of which is notified the store 20 by the notifying unit 212, is not confirmed in the store.

For example, the unconfirmed order information detecting unit 208 may detect unconfirmed order receiving information according to the time information supplied from the time indicating unit 210. For example, the unconfirmed order information detecting unit 208 may detect unconfirmed order receiving information for every predetermined time according to time information supplied from the time indicating unit 210. For example, the unconfirmed order information detecting unit 208 may detect unconfirmed order receiving information according to time information supplied from the time indicating unit 210 and the order time stored in the information storing unit 300.

In case of a predetermined situation, the unconfirmed order information detecting unit 208 directs the change request notifying unit 206 to notify a request terminal of change request information requesting change of ordered merchandise. For example, in case the unconfirmed order information detecting unit 208 detects unconfirmed order receiving information of which the order time stored in the information storing unit 300 is a predetermined time ago, the unconfirmed order information detecting unit 208 may direct the change request notifying unit 206 to notify request terminal of change requesting information. For example, in case the number notified is bigger than a predetermined number, the unconfirmed order information detecting unit 208 may direct the change request notifying unit 206 to notify the request terminal of change requesting information. In case the change request notifying unit 206 is directed to notify the request terminal of change requesting information from the unconfirmed order information detecting unit 208, the change request notifying unit 206 notifies a request terminal of change requesting information. Therefore, in case notifying information is not confirmed in a store, it is possible to change the store to which the order is placed.

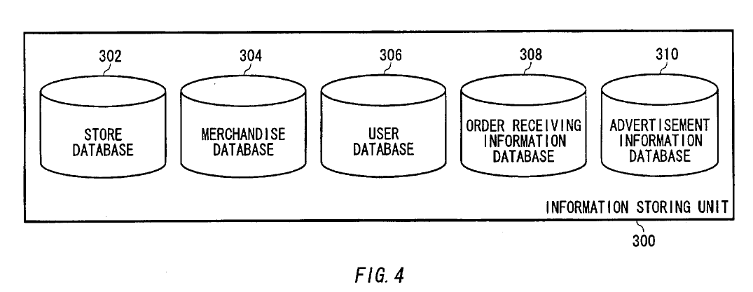

FIG. 4 shows an example of a database stored in the information storing unit 300. The information storing unit 300 includes a store database 302, a merchandise database 304, a user database 306, an order receiving information database 308 and an advertisement information database 310. The store database 302 maintains store information. The merchandise database 304 maintains merchandise information. The user database maintains user information. The order receiving information database 308 maintains order receiving information. The advertisement information database maintains advertisement information.

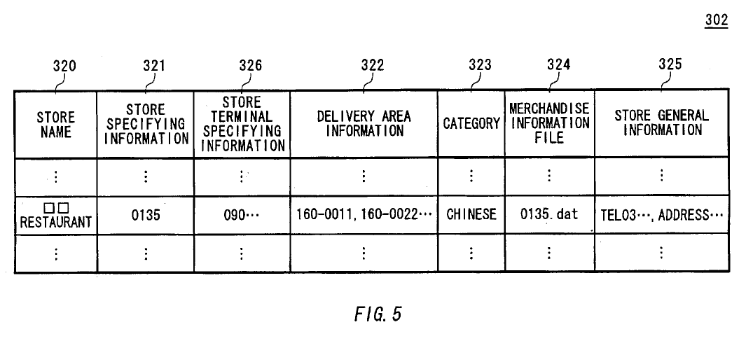

FIG. 5 shows an example of a data-structure of the store database 302. The store database 302 includes a store name 320, store specifying information 321, delivery area information 322, a category 323, merchandise information 324, store general information 325 and store terminal specifying information 326. The store name 320 maintains names of stores. The store specifying information 321 maintains information specifying stores. The store terminal specifying information 326 maintains information specifying store terminals related to stores. For example, in case the store terminal 20 is a mobile station in the wireless system, the store terminal specifying information 326 may be a telephone number of the mobile station. The delivery area information 322 maintains information of delivery area. For example, the delivery area information 322 may be the postal number of delivery area. The category 323 maintains categories showing merchandise type dealt with. The merchandise information file 324 maintains storage location of the merchandise information file which maintains merchandise information of merchandise dealt with. The store general information 325 maintains addresses and telephone numbers of stores.

The selecting unit 112, described with reference to FIG. 2, selects a store on the basis of location information supplied from location information acquiring unit 106 and delivery area kept and maintained by delivery area information 322. In addition, the selecting unit 112 selects merchandise dealt with by the store on the basis of the merchandise information 324. Therefore, the providing information producing unit 116 provides merchandise information in response to location information of the user's mobile or fixed terminal 16 or 18.

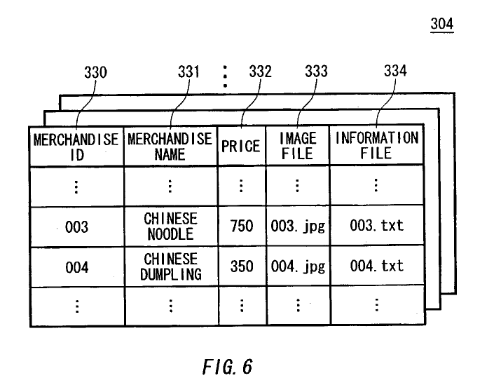

FIG. 6 shows an example of a data-structure of the merchandise database 304.

The merchandise database 304 includes merchandise ID 330, merchandise name 331, price 332, image file 333 and information file 334. The merchandise ID 330 maintains merchandises dealt with by each store and information specified by each store. The merchandise name 331 maintains names of merchandise. The price 332 maintains prices. The image file 333 maintains storage location where image data of merchandise is kept and maintained. The information file 334 maintains storage location where merchandise information, such as comment, is kept and maintained. The merchandise database 304 has the merchandise ID 330, the merchandise name 331, the price 332, the picture file 333 and the information file 334 for each and every store. Therefore, the selecting unit 112 selects merchandise dealt with by the store selected.

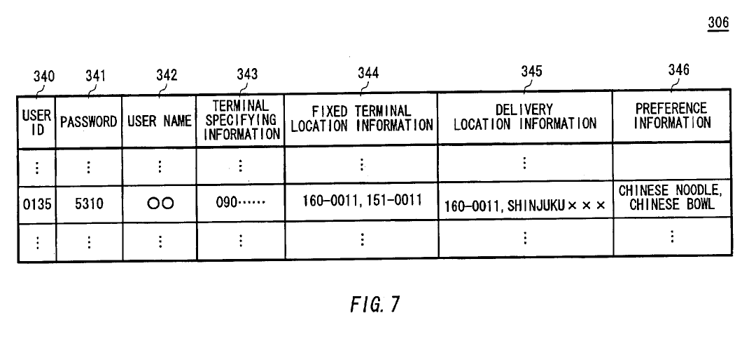

FIG. 7 shows an example of a data-structure of the user database 306. The user database 306 includes user ID 340, password 341, user name 342, terminal information 343, fixed terminal location information 344, delivery location information 345, preference information 346 and setting information 347. The user ID 340 maintains information specifying users. The password 341 maintains passwords used to certify users. The user name 342 maintains users” names. The terminal specifying information maintains information specifying user's mobile terminal 16. For example, information specifying user's mobile terminal may be a telephone number of the user's mobile terminal. The fixed terminal location information 344 maintains location information of the user's fixed terminal. For example, it is preferred that location information of the user's fixed terminal is set in advance by the user.

The delivery location information 345 maintains information indicating delivery place of merchandise ordered. For example, the information may be an address of a building where the user's fixed terminal has been installed. For example, it is preferred that an address stored in the delivery location information 345 is set in advance by the user.

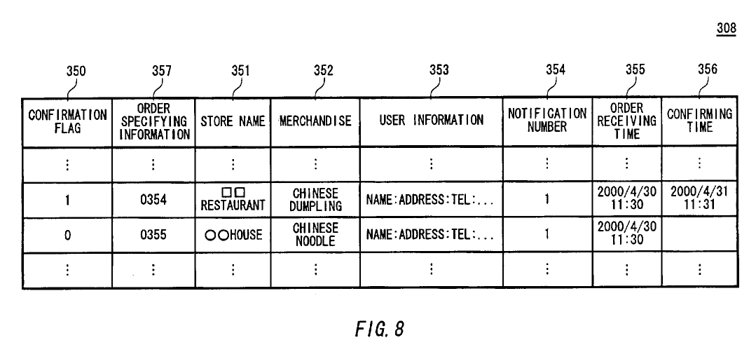

FIG. 8 shows an example of a data-structure of the order information database 308. The order information database includes a confirmation flag 350, order specifying information 358, a store name 351, merchandise 352, user information 353, a notification number 354, an order receiving time 355, a confirming time 356 and order specifying information 357. The confirmation flag 350 maintains information indicating that confirmation information has been provided. The confirmation information inputting unit 204, described with reference to FIG. 3, maintains information indicating the fact of confirmation in the confirmation flag 350, when confirmation information has been inputted. The order specifying information 357 maintains information specifying order information. The store name 351 maintains names of stores dealing with related merchandise. The merchandise 352 maintains merchandise ordered. For example, name of merchandise and amount of the merchandise may be stored, correspondingly to each other.

For example, merchandise ID and amount of the merchandise may be stored, correspondingly to each other. The advertisement information selecting unit 114, described with reference to FIG. 2, selects advertisement information on the basis of the merchandise 352 and the user information stored in the order information database 308. For example, the advertisement information selecting unit 114 selects advertisement information in response to merchandise kept and maintained by the merchandise 352. For another example, the advertisement information selecting unit 114 may select advertisement information in response to the amount of merchandise kept and maintained by the merchandise 352.

The user information 353 maintains information of users. For example, information of users includes user name, delivery place, contact address, etc. The notification number 354 maintains the number of how many times the notifying information has been notified to the store terminal 20. For example, the notifying unit 212, described with reference to FIG. 3, maintains the notification number in the notification number 354. The order receiving time 355 maintains the time when order information supplied from the request terminal is inputted. For example, the order receiving information producing unit 216, described with reference to FIG. 3, maintains the order time in the order receiving time 355. For another example, the order receiving information producing unit 216 may keep and maintain hour and/or date information, when the information inputting unit 218 has inputted order information, in the order receiving time 355. The confirming time 356 maintains time when confirmation information supplied from the store terminal 20 is inputted. For example, the confirmation information inputting unit 204, described with reference to FIG. 3, maintains confirming time in the confirming time 356. For another example, the confirmation information inputting unit 204 may keep and maintain confirming hour and/or date information in the confirming time 356.

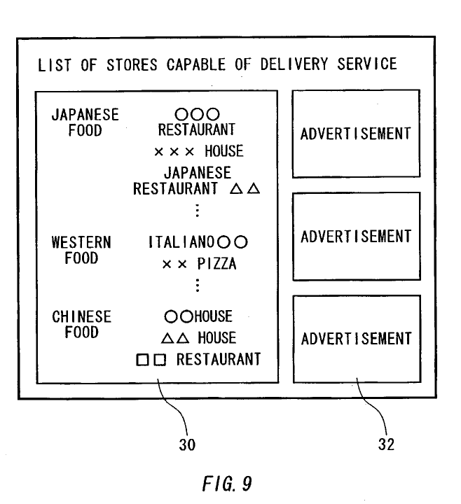

FIG. 9 shows an example of a displaying screen on the displaying unit of the request terminal according to providing information provided to the request terminal by the information providing unit 118, described with reference to FIG. 2. The screen displayed according to providing information includes a store information displaying section 30 and an advertisement information displaying section 32. The store information displaying section 30 displays store information selected by the selecting unit 112. The advertisement information displaying section 32 displays advertisement information selected by the advertisement information selecting unit 114. For example, in case the information providing apparatus 100 provides the providing information of HTML-type to the request terminal, the user requests the information providing unit 100 to provide information by using an HTML browser. The information providing apparatus 100 provides HTML-type information including the store information displaying section 30 to the request terminal. The request terminal analyzes the HTML-type information by using the HTML browser and displays a screen indicated by HTML.

The user selects merchandise in the store information displaying section 30. For example, in case a store displayed on the store information displaying section 30 is corresponded to a direction requesting the information providing request inputting unit 102 for information on merchandise dealt with by the store when the store is designated by a predetermined inputting device, the user may designate a store by the predetermined inputting device. For example, the predetermined inputting device may be a mouse, a keyboard, a touch panel, or etc.

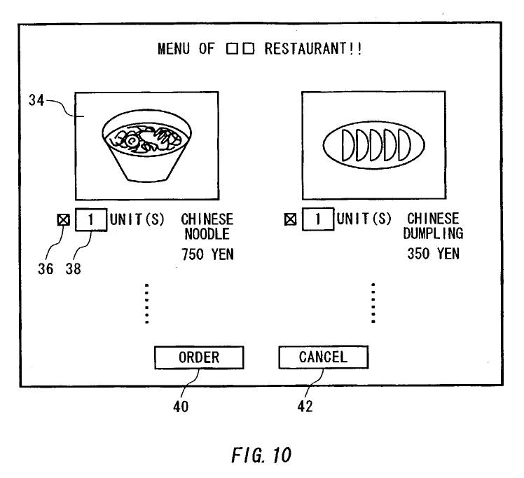

FIG. 10 shows another example of the displaying screen on the displaying unit of the request terminal according to providing information provided to the request terminal by the information providing unit 118 described with reference to FIG. 2. The screen displayed according to the providing information includes a merchandise image displaying section 34, an ordered merchandise designating unit 36, an amount indicating unit 38, an order button 40 and a cancel button 42. The merchandise image displaying section 34 displays an image of merchandise dealt with by the store and merchandise information. The selecting unit 112, described with reference to FIG. 2, selects merchandise information displayed on the image displaying section 34 from the merchandise database 304 described with reference to FIG. 6.

The ordered merchandise designating unit 36 is a unit for determining whether or not an order is placed. The ordered merchandise designating unit 36 may be corresponded to each merchandise displayed on the merchandise image displaying section 34. The request terminal outputs merchandise designated by the ordered merchandise designating unit 36 as order information to the order receiving apparatus 200.

The amount designating unit 38 is a unit for designating the amount of ordered merchandise. The amount designating unit 38 may be corresponded to each merchandise displayed on the merchandise image displaying section 34. The request terminal outputs the merchandise and the amount designated by the amount designating unit 38 as order information to the order receiving apparatus 200.

The order button 40 is a button for directing the order receiving apparatus 200 to output the order information. For example, in case the user directs the order receiving apparatus 200 to output the order information, the order button 40 is designated by a predetermined inputting device. The cancel button 42 is a button for directing cancellation of the order of merchandise. In this way, users orders merchandises.

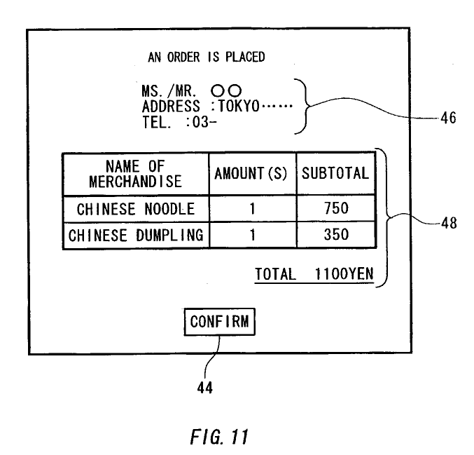

FIG. 11 shows an example of a displaying screen on the displaying unit of the store terminal 20 according to notifying information notified to the store terminal 20 by the notifying unit 212 described with reference to FIG. 3. The displaying screen on the displaying unit of the store terminal 20 includes a user information displaying section 46, an ordered merchandise information displaying section 48 and a confirm button 44. The user information displaying section 46 displays information of users, such as users names, addresses of delivery places, telephone numbers and etc. The order merchandise information displaying section 48 displays information of merchandise ordered by a user. For example, the notifying information producing unit 214, described with reference to FIG. 3, produces the user information displaying section 46 and the ordered merchandise information displaying section 48 through the order information database 308. The confirm button 44 is a button for directing to output the confirmation information, which indicates the fact of confirmation, to the confirmation information inputting unit 204.

For example, in case a store clerk has confirmed the notifying information, the clerk designates the confirm button by a predetermined inputting device. In this way, the order receiving apparatus 200 determines whether or not the notifying information is confirmed in a store. Further, it is possible to provide information in response to location information of the users terminal. And, it is also possible to determine whether or not the store receives and confirms the order.

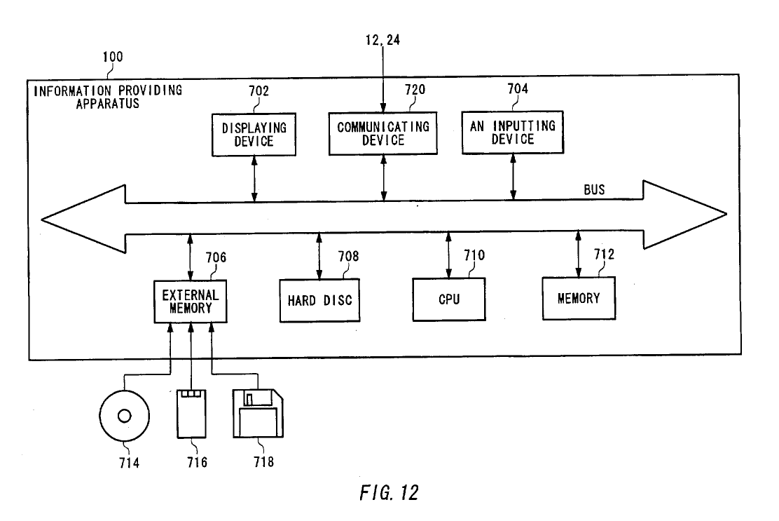

FIG. 12 shows an example of a functional block diagram of hardware of information providing apparatus 100. The information providing apparatus 1 includes a displaying device 702, an inputting device 704, a communicating device 720, an external memory 706, a hard disc 708, a CPU 710 and a memory 712. The functional block diagram of the information providing apparatus described with reference to FIG. 2 is formed to execute a predetermined program with the above described hardware. This program may be stored in the hard disc 708 and executed by the CPU 710. In addition, this program may be stored in the external memory 706, such as an optical memory media (e.g. CD-ROM) 714, a semiconductor memory media (e.g. a memory card) 716, a magnetic memory media (e.g. a floppy disc) 718 and etc. Further, this program may be compressed to be stored.

The inputting device is a device, with which a user inputs predetermined information, for example, a keyboard, a mouse, a touch panel and etc. The communicating device transmits and receives information via the private network 12 and the network 24. According to another embodiment of the present invention, the order receiving apparatus 200 may be equipped with hardware having the hardware blocks described with reference to FIG. 12. In addition, the functional blocks of the order receiving apparatus 200 described with reference to FIG. 3 may be embodied by the execution of a predetermined program with the above described hardware.

Although the present invention has been described by way of exemplary embodiments, it should be understood that those skilled in the art might make many changes and substitutions without departing from the spirit and the scope of the present invention which is defined only by the appended claims. According to the claims, it is apparent that the various modifications or changes are also within the technical scope of the present invention.

It is apparent from the above description that, according to the present invention, information can be provided on the basis of location information.

1. An order receiving system for receiving a merchandise order, comprising:
an information providing unit for providing to a terminal merchandise information comprising merchandise specifying information which specifies said merchandise;
an order information inputting unit for inputting said merchandise specifying information supplied from said terminal which has received said merchandise information;
a notifying unit for notifying a store terminal related to a store dealing with said merchandise of order information of said merchandise according to said merchandise specifying information inputted into said order information inputting unit;
a confirmation information inputting unit for inputting confirmation information, which indicates that said order information has been confirmed, from said store terminal;
an order information storing unit for storing said order information and said confirmation information with making said order and confirmation information be corresponding to each other; and
an unconfirmed order information detecting unit for detecting said order information which does not have any confirmation information corresponded to it, and making said notifying unit notify of said order information again.

2. An order receiving system as claimed in claim 1, further comprising:
a location information acquiring unit for acquiring location information of said terminal;
an information storing unit for storing said merchandise information and area information of an area, where said merchandise information is valid, with making said merchandise information be corresponding to said area information; and
a selecting unit for selecting said merchandise information, which is provided to said terminal, from said information storing unit according to said location information and said area information,
wherein said information providing unit provides said merchandise information selected by said selecting unit to said terminal.

3. An order receiving system as claimed in claim 2, further comprising a terminal recognizing unit for detecting whether or not said terminal is a mobile station of a wireless system,
wherein said location information acquiring unit comprises:
a mobile terminal location information acquiring unit for acquiring said location information of said terminal from a location information providing apparatus which provides said location information of said terminal, in case said terminal is a mobile station; and
a fixed terminal location information acquiring unit for acquiring said location information of said terminal stored in advance, in case said terminal is not a mobile station.

4. An order receiving apparatus for receiving a merchandise order, comprising:
an order information inputting unit for inputting merchandise specifying information which specifies said merchandise from said terminal;
a notifying unit for notifying a store terminal related to a store dealing with said merchandise of order information of said merchandise according to said merchandise specifying information;
a confirmation information inputting unit for inputting confirmation information, which indicates that said order information has been confirmed, from said store terminal;
an order information storing unit for storing said order information and said confirmation information with making said order and confirmation information be corresponding to each other; and
an unconfirmed order information detecting unit for detecting said order information which does not have any confirmation information corresponded to it, and making said notifying unit notify of said order information again.

5. An order receiving apparatus as claimed in claim 4, further comprising a confirmation notifying unit for notifying said terminal, which provides said merchandise specifying information to said order information inputting unit, of receipt information showing that said merchandise order is received, in case said confirmation information inputting unit inputs said confirmation information.

6. An order receiving apparatus as claimed in claim 5,
wherein said unconfirmed order information detecting unit detects said order information, which is not corresponded to said confirmation information, for a predetermined time period.

7. An order receiving apparatus as claimed in claim 6 further comprising a change request notifying unit for notifying said terminal of change request information requesting change of said merchandise,
wherein said unconfirmed order information detecting unit notifies said change request notifying unit of said change request information, in case order information which is not corresponded to said confirmation information is detected.

8. An information providing apparatus for providing information, comprising:
an information storing unit for storing said information and area information, which designates an area where said information is valid, with making said information be corresponding to said area information;
a location information acquiring unit for acquiring location information of a terminal which provides said information; and
a selecting unit for selecting said information provided to said terminal according to said area information and said location information; and
an information providing unit for providing said information selected by said selecting unit to said terminal.

9. An information providing apparatus as claimed in claim 8, further comprising a terminal recognizing unit for detecting whether or not said terminal is a mobile station of a wireless system,
wherein said location information acquiring unit comprises:
a mobile terminal location information acquiring unit for acquiring said location information of said terminal from a location information providing apparatus which provides said location information of said terminal, in case said terminal is a mobile station; and
a fixed terminal location information acquiring unit for acquiring said location information of said terminal stored in advance, in case said terminal is not a mobile station.

10. A computer readable recording medium on which a computer program is recorded, said program comprising:
a module for inputting merchandise specifying information which specifies said merchandise;
a module for notifying a store terminal related to a store dealing with said merchandise of order information of said merchandise according to said merchandise specifying information;
a module for inputting confirmation information, which indicates that said order information has been confirmed, from said store terminal;
a module for storing said order information and said confirmation information with making said order and confirmation information be corresponding to each other; and
a module for detecting said order information which does not have any confirmation information corresponded to it, and making said order information be notified again.

11. A computer readable recording medium on which a computer program is recorded, said program comprising:
a module for storing a predetermined information and area information, which designates an area where said predetermined information is valid, with making said predetermined information be corresponding to said area information;
a module for acquiring location information of a terminal which provides said predetermined information; and
a module for selecting said predetermined information provided to said terminal according to said area information and said location information; and
a module for providing said selected predetermined information to said terminal.
